(19) United States
(12) Patent Application Publication
(10) Pub. No.: US 2019/0024391 A1
(43) Pub. Date: Jan. 24, 2019

(54) Painting Tool

(71) Applicant: Chin-Chen Huang, Taichung City (TW)

(72) Inventor: Chin-Chen Huang, Taichung City (TW)

(21) Appl. No.: 15/657,070

(22) Filed: Jul. 21, 2017

(51) Int. Cl. E04F 21/02; B08B 1/00

(52) U.S. Cl. CPC E04F 21/026; B08B 1/005

(57) ABSTRACT

A painting tool includes a body having a gripping portion, an abutting portion, and a projecting board. The gripping portion is located on a first side of the body and protrudes from an upper surface of the body. The abutting portion is formed on a bottom surface of the body and protrudes from a bottom of the gripping portion toward a second side of the body. The projecting board protrudes from the bottom surface of the gripping portion toward the second side of the body. A coupling groove is defined between the projecting board and the abutting portion and has an opening facing the second side of the body. A knife board includes a first side having a coupling portion coupled with the coupling groove. A levelling portion is formed on a second side of the knife board.

### BACKGROUND OF THE INVENTION

### 1. Field of the Invention

The present invention relates to a painting tool and, more particularly, to a painting tool that is easy to disassemble and that is easy to grip.

### 2. Description of the Related Art

FIG. 1 shows a conventional scraper 9 for painting. The conventional scraper 9 is used to level a wall surface to be painted. The conventional scarper 9 includes a handle 91 and a knife board 92 fixed to the handle 91 by screws. When replacement of the knife board 92 is required, a wrench or a screwdriver is required to remove the screws for removing the knife board 92 and subsequent assembly of a new knife board 92. Since the screws are apt to become loosened after a period of time of use, the screws must be retightened, which is inconvenience in use.

Furthermore, when using the conventional scraper 9, a user has to hold the handle 91 to keep the knife board 92 at an inclination angle to the wall surface or the ground for removing protrusions on the wall surface or the ground or to fill holes in the wall or the ground with fillings. Thus, the knife board 92 must be at an angle generally smaller than 90° to the wall surface or the ground. In a case that the angle is small, the protrusions are easier to remove, and the fillings are more smooth after filling the holes. However, the small angle also easily causes the fingers of the user to be in frictional contact with the wall surface or the ground, leading to scratched fingers of the user.

Thus, improvement to the conventional scrapers is desired.

### SUMMARY OF THE INVENTION

To solve the above disadvantages, an objective of the present invention is to provide a painting tool including a body and a knife board easily and reliably coupled to and removable from the body, permitting easy replacement of the knife board.

Another objective of the present invention is to provide a painting tool including a body that can be easily gripped by a user and that permits easy operation.

When the terms “front”, “rear”, “up”, “down”, “top”, “bottom”, “inner”, “outer”, “side”, and similar terms are used herein, it should be understood that these terms have reference only to the structure shown in the drawings as it would appear to a person viewing the drawings and are utilized only to facilitate describing the invention, rather than restricting the invention.

A painting tool according to the present invention includes a body having a gripping portion, an abutting portion, and a projecting board. The gripping portion is located on a first side of the body and protrudes from an upper surface of the body. The abutting portion is formed on a bottom surface of the body and protrudes from a bottom of the gripping portion toward a second side of the body. The projecting board protrudes from the bottom surface of the gripping portion toward the second side of the body. A coupling groove is defined between the projecting board and the abutting portion and has an opening facing the second side of the body. A knife board includes a first side and a second side. The first side of the knife board includes a coupling portion coupled with the coupling groove. A levelling portion is formed on the second side of the knife board.

Thus, the body of the painting tool according to the present invention includes the gripping portion to permit easy gripping, avoiding scratch of the fingers of the user resulting from frictional contact with the wall surface or the ground. Furthermore, the coupling mechanism between the knife board and the body permits easy replacement of the knife board.

In an example, the cross sectional area of a top portion of the gripping portion is larger than the cross sectional area of a bottom portion of the gripping portion. Thus, the user can easily grip the body.

In an example, the top portion of the gripping portion includes an arcuate surface. The gripping portion further includes two lateral sides extending between the top portion and the bottom portion of the gripping portion. Each of the two lateral sides includes a recessed portion to provide easy gripping of the gripping portion.

In an example, a limiting member is formed in the opening of the coupling groove. The coupling portion of the knife board includes a plurality of positioning portions. The plurality of positioning portions is configured to abut against the limiting member. Thus, the knife board can be more securely coupled in the coupling groove.

In an example, the limiting member is an elongated ridge or includes a plurality of protrusions. Thus, the limiting member can provide a limiting effect by abutting against the plurality of positioning portions.

In an example, the body is a hollow structure and includes a plurality of coupling holes extending through two ends of the body, saving the material for manufacturing the body and reducing the weight of the body.

In an example, the plurality of positioning portions is formed by punching a bottom surface of the coupling portion of the knife board, such that the plurality of positioning portions protrudes outward from a top surface of the coupling portion, permitting easy processing.

In an example, the knife board includes a bend adjacent to the coupling portion to provide an angle between the coupling portion and the levelling portion. The angle is in a range between 150° and 170°, permitting the knife board to abut the abutting portion of the body.

In an example, the angle between the coupling portion and the levelling portion is 160°, permitting the knife board to abut the abutting portion of the body.

In an example, the painting tool further includes two caps coupled to the two end faces of the body. The body includes a plurality of coupling holes. Each of the two caps includes a plurality of positioning members complementary to the plurality of coupling holes. Thus, the two caps can be securely coupled to the two end faces of the body.

In another example, the body includes a plurality of coupling holes, and each of the two caps includes a plurality of positioning members. Each of the plurality of positioning members abuts an inner periphery of a corresponding one of the plurality of coupling holes Thus, the two caps can be securely coupled to the two end faces of the body, improving the sense of quality of the appearance of the body while avoiding deviation in a transverse direction during use of the knife board.

The present invention will become clearer in light of the following detailed description of illustrative embodiments of this invention described in connection with the drawings.

### BRIEF DESCRIPTION OF THE DRAWINGS

FIG. 1 is a side elevational view of a conventional scraper for painting.

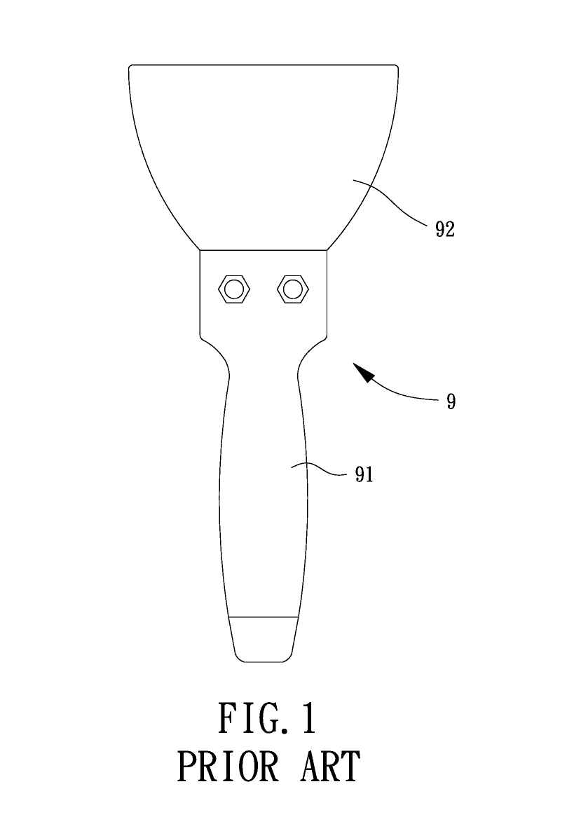

FIG. 2 is an exploded, perspective view of a painting tool of an embodiment according to the present invention.

FIG. 3 is a partly-exploded cross sectional view of the painting tool of an embodiment according to the present invention.

FIG. 4 is a cross sectional view of the painting tool of an embodiment according to the present invention after assembly.

FIG. 5 is a perspective view illustrating detachment of the painting tool of an embodiment according to the present invention.

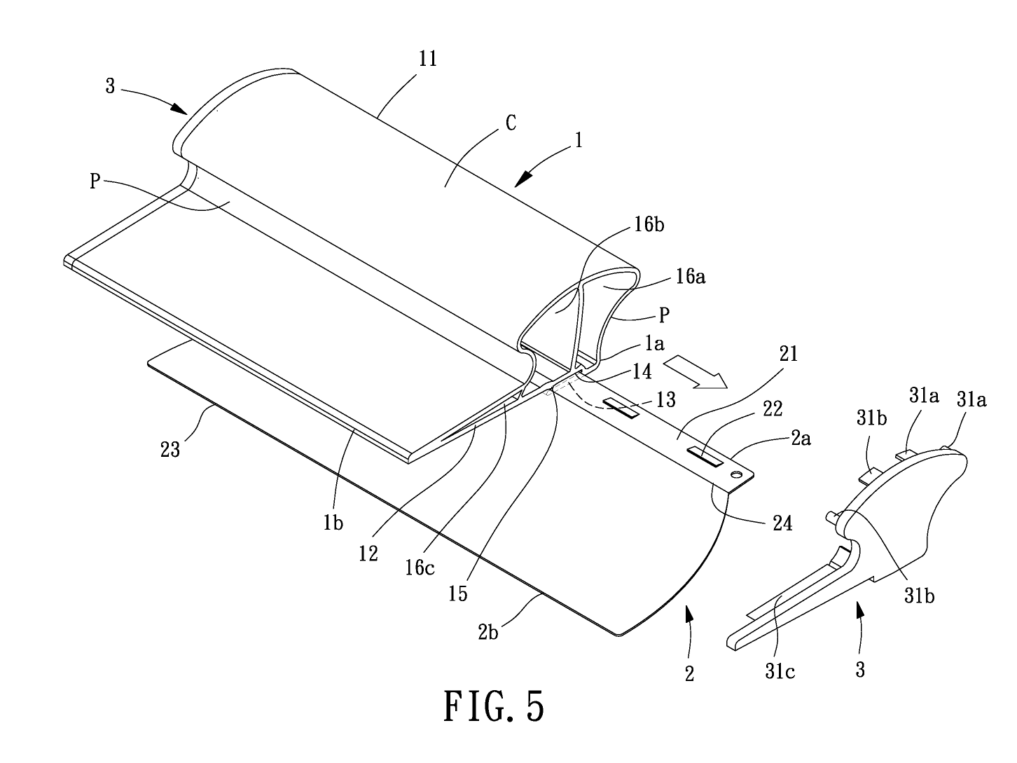

### DETAILED DESCRIPTION OF THE INVENTION

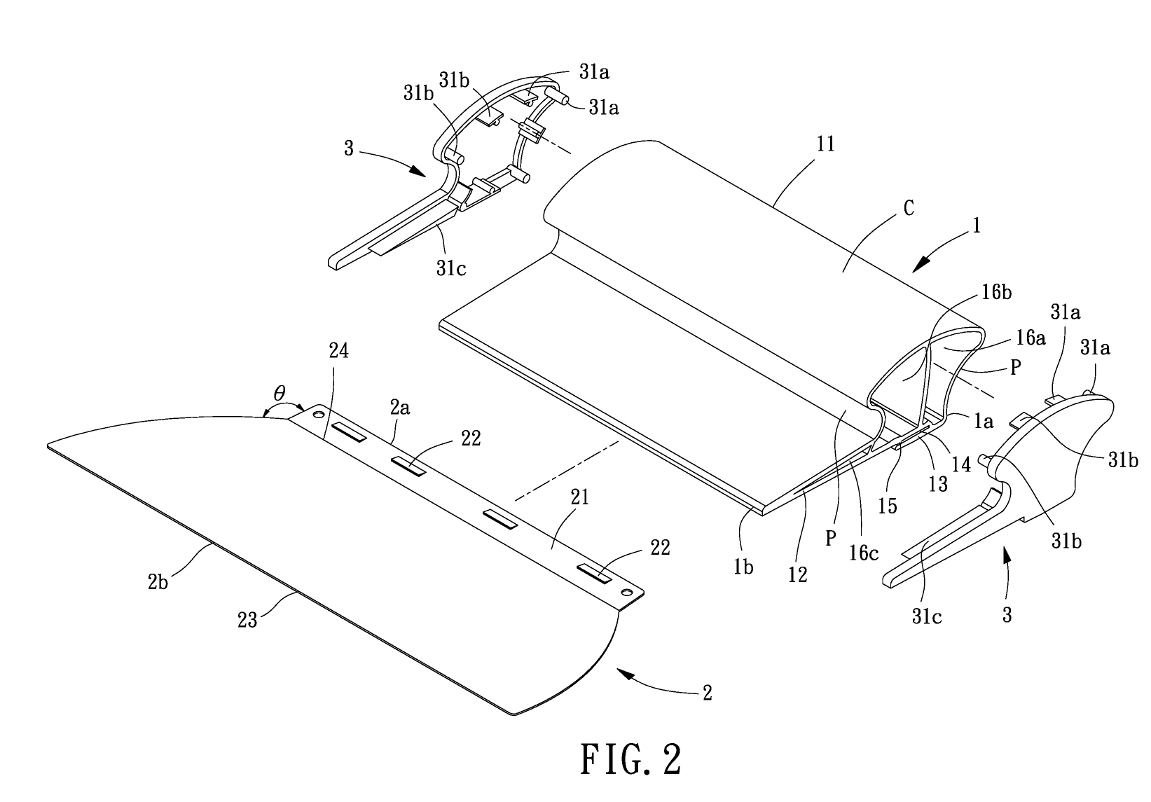

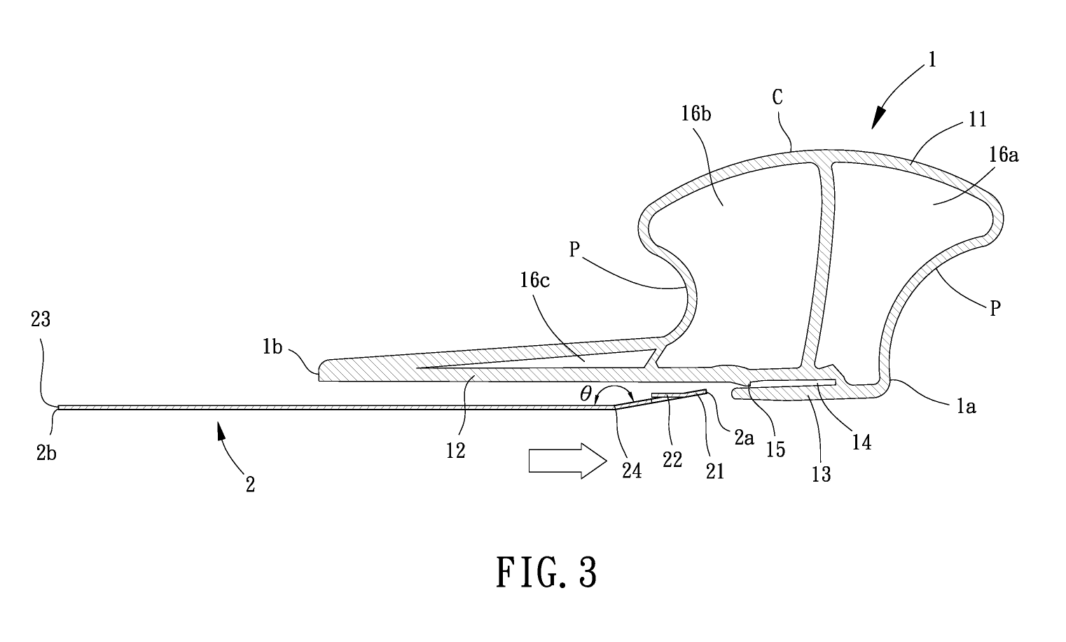

With reference to FIGS. 2 and 3, a painting tool of an embodiment according to the present invention includes a body 1 and a knife board 2. The knife board 2 can be easily coupled with a coupling groove 14 of the body 1 and can be removed out of the coupling groove 14.

The body 1 includes a gripping portion 11, an abutting portion 12, and a projecting board 13. The gripping portion 11 is located on a first side 1a of the body 1 and protrudes from an upper surface of the body 1. Preferably, the cross sectional area of a top portion of the gripping portion 11 is larger than the cross sectional area of a bottom portion of the gripping portion 11, permitting easy gripping of the body 1 by a user. Preferably, the top portion of the gripping portion 11 includes an arcuate surface C. Furthermore, the gripping portion 11 includes two lateral sides extending between the top portion and the bottom portion of the gripping portion 11. Each of the two lateral sides includes a recessed portion P for gripping by the fingers of the user. Thus, the gripping portion 11 can be easily gripped. The abutting portion 12 is formed on a bottom surface of the body 1 and protrudes from a bottom of the gripping portion 11 toward a second side 1b of the body 1. Preferably, the abutting portion 12 is planar. The projecting board 13 protrudes from the bottom surface of the gripping portion 11 toward the second side 1b of the body 1. A coupling groove 14 is defined between the projecting board 13 and the abutting portion 12 and has an opening facing the second side 1b of the body 1. Preferably, a limiting member 15 is formed in the opening of the coupling groove 14. The limiting member 15 can be an elongated ridge or includes a plurality of protrusions. Preferably, the body 1 is a hollow structure to save the material for manufacturing the body 1 and to reduce the weight of the body 1. The body 1 includes a plurality of coupling holes 16a, 16b, and 16c extending through two ends of the body 1.

Still referring to FIGS. 2 and 3, the knife board 2 includes a first side 2a and a second side 2b. The first side 2a of the knife board 2 includes a coupling portion 21 for coupling with the coupling groove 14 of the body 1. Preferably, the coupling portion 21 of the knife board 2 includes a plurality of positioning portions 22 configured to abut against the limiting member 15. Thus, the knife board 2 can be securely coupled in the coupling groove 14. Preferably, the positioning portions 22 are formed by punching a bottom surface of the coupling portion 21 of the knife board 2, such that the positioning portions 22 protrude outward from a top surface of the coupling portion 21, permitting easy processing. A levelling portion 23 is formed on the second side 2b of the knife board 2. The levelling portion 23 can be used to level a wall surface or the ground. The knife board 2 further includes a bend 24 adjacent to the coupling portion 21 to provide an angle θ between the coupling portion 21 and the levelling portion 23. The angle θ is in a range between 150° and 170°, permitting the knife board 2 to abut the abutting portion 12 of the body 1. Preferably, the angle θ between the coupling portion 21 and the levelling portion 23 is 160°. Thus, when the coupling portion 21 is coupled in the coupling groove 14 of the body 1, the knife board 2 abuts the abutting portion 12.

The painting tool can further include two caps 3 coupled to the two end faces of the body 1. Each cap 3 includes a plurality of positioning members 31a, 31b, and 31c that can be inserted into the coupling holes 16a, 16b, and 16c. The positioning members 31a, 31b, and 31c can be complementary to the coupling holes 16a, 16b, and 16c. Alternatively, each positioning member 31a, 31b, 31c can abut an inner periphery of a corresponding one of the coupling holes 16a, 16c, and 16c, coupling the two caps 3 to the two end faces of the body 1.

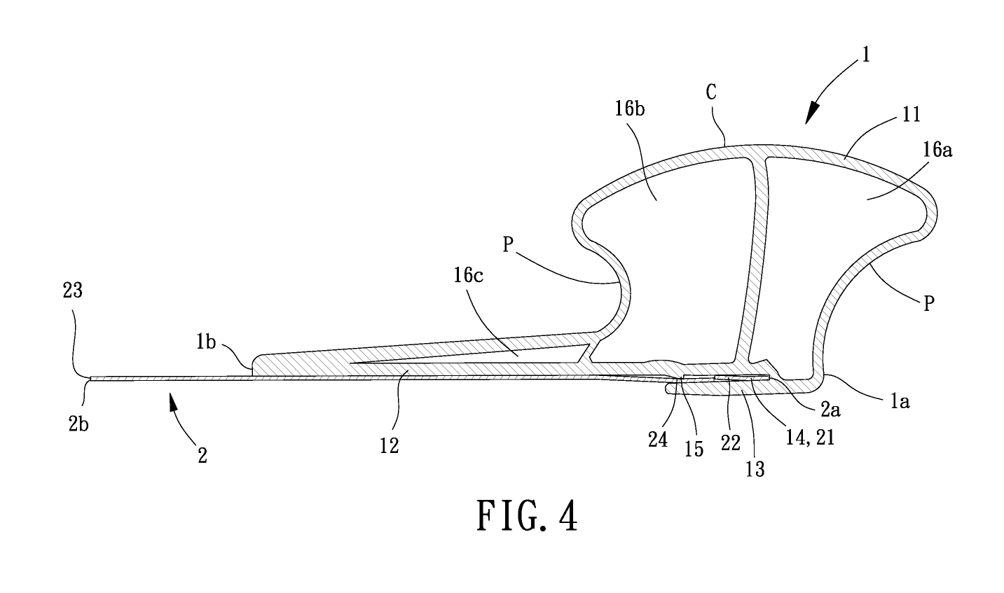

With reference to FIGS. 3 and 4, the knife board 2 can be coupled with the coupling groove 14 of the body 1 by the engaging portion 2. Furthermore, the positioning portions 22 of the knife board 2 can abut against the limiting member 15, such that the knife board 2 can be more securely coupled in the coupling groove 14. Furthermore, the bend 24 of the knife board 2 provides an angle θ to permit the knife board 2 to abut the abutting portion 12. Furthermore, two caps 3 can be coupled to the two end faces of the body 1 to cover the coupling holes 16a, 16b, and 16c, improving the sense of quality of the appearance of the body 1 while avoiding deviation in a transverse direction during use of the knife board 2.

When it is desired to replace the knife board 2, one of the end caps 3 is removed from an end of the body 1, and the knife board 2 is moved relative to the body 1 in the transverse direction. Thus, the knife board 2 can be smoothly removed. Then, the coupling portion 21 of another knife board 2 is inserted into the coupling groove 14 of the body 1. Thus, replacement of the knife board 2 can be easily accomplished without any tools, permitting easy replacement of the knife board 2.

In view of the foregoing, the body 1 of the painting tool according to the present invention includes the gripping portion 11 to permit easy gripping, avoiding the user from scratching the fingers due to frictional contact with the wall surface or the ground. Furthermore, the coupling mechanism between the knife board 2 and the body 1 permits easy replacement of the knife board 2.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A painting tool comprising:
a body including a gripping portion, an abutting portion, and a projecting board, wherein the gripping portion is located on a first side of the body and protrudes from an upper surface of the body, wherein the abutting portion is formed on a bottom surface of the body and protrudes from a bottom of the gripping portion toward a second side of the body, wherein the projecting board protrudes from the bottom surface of the gripping portion toward the second side of the body, and wherein a coupling groove is defined between the projecting board and the abutting portion and has an opening facing the second side of the body; and
a knife board includes a first side and a second side, wherein the first side of the knife board includes a coupling portion coupled with the coupling groove, and wherein a levelling portion is formed on the second side of the knife board.

2. The painting tool as claimed in claim 1, wherein a cross sectional area of a top portion of the gripping portion is larger than a cross sectional area of a bottom portion of the gripping portion.

3. The painting tool as claimed in claim 2, wherein the top portion of the gripping portion includes an arcuate surface, wherein the gripping portion further includes two lateral sides extending between the top portion and the bottom portion of the gripping portion, and wherein each of the two lateral sides includes a recessed portion.

4. The painting tool as claimed in claim 1, wherein a limiting member is formed in the opening of the coupling groove, wherein the coupling portion of the knife board includes a plurality of positioning portions, and wherein the plurality of positioning portions is configured to abut against the limiting member.

5. The painting tool as claimed in claim 4, wherein the limiting member is an elongated ridge or includes a plurality of protrusions.

6. The painting tool as claimed in claim 1, wherein the body is a hollow structure and includes a plurality of coupling holes extending through two ends of the body.

7. The painting tool as claimed in claim 1, wherein the plurality of positioning portions is formed by punching a bottom surface of the coupling portion of the knife board, and wherein the plurality of positioning portions protrudes outward from a top surface of the coupling portion.

8. The painting tool as claimed in claim 1, wherein the knife board includes a bend adjacent to the coupling portion to provide an angle between the coupling portion and the levelling portion, and wherein the angle is in a range between 150° and 170°, permitting the knife board to abut the abutting portion of the body.

9. The painting tool as claimed in claim 8, wherein the angle between the coupling portion and the levelling portion is 160°.

10. The painting tool as claimed in claim 1, further comprising two caps coupled to the two end faces of the body.

11. The painting tool as claimed in claim 10, wherein the body includes a plurality of coupling holes, and wherein each of the two caps includes a plurality of positioning members complementary to the plurality of coupling holes.

12. The painting tool as claimed in claim 10, wherein the body includes a plurality of coupling holes, wherein each of the two caps includes a plurality of positioning members, and wherein each of the plurality of positioning members abuts an inner periphery of a corresponding one of the plurality of coupling holes, coupling the two caps to the two end faces of the body.
